(19) United States
(12) Patent Application Publication
(10) Pub. No.: US 2021/0008943 A1
(43) Pub. Date: Jan. 14, 2021

(54) ELECTRIC SUSPENSION DEVICE

(71) Applicant: HONDA MOTOR CO., LTD., Tokyo (JP)

(72) Inventors: Tomoya TOYOHIRA, Wako-shi (JP); Takafumi KATO, Wako-shi (JP); Atsuhiko YONEDA, Wako-shi (JP)

(21) Appl. No.: 16/925,790

(22) Filed: Jul. 10, 2020

(30) Foreign Application Priority Data
Jul. 12, 2019 (JP) 2019-130488

(51) Int. Cl. B60G 17/015; B60G 17/018

(52) U.S. Cl. CPC B60G 17/0157; B60G 2800/916; B60G 17/0182

(57) ABSTRACT

An electric suspension device, includes: an electromagnetic actuator which is arranged in parallel to a spring member provided between a body and a wheel of a vehicle and produces a drive force concerning damping operation and expansion-contraction operation; an information acquisition section which acquires roll velocity of the vehicle; a damping force calculation section which calculates a target damping force as a target value for the damping operation of the electromagnetic actuator; and an ECU which performs drive control for the electromagnetic actuator using a target drive force based on the calculated target damping force. The damping force calculation section calculates a standard damping force of the electromagnetic actuator as a standard value, calculates a supplementary damping force which supplements the standard damping force based on the roll velocity acquired by the information acquisition section, and adds the calculated standard and supplementary damping forces to calculate the target damping force.

### BACKGROUND OF THE INVENTION

### 1. Field of the Invention

The present invention relates to an electric suspension device including an electromagnetic actuator which is arranged in parallel a spring member provided between the body and each wheel of a vehicle and which produces a drive force concerning damping operation and expansion-contraction operation.

### 2. Description of the Related Art

The applicant of the present invention has proposed an electric suspension device including an electromagnetic actuator which is arranged in parallel to a spring member provided between the body and each wheel of a vehicle and which produces a drive force concerning damping operation and expansion-contraction operation (see Japanese Patent Publication No. 6417443 (Patent Literature 1), for example). The electromagnetic actuator includes a ball screw mechanism in addition to an electric motor. The electromagnetic actuator converts rotary motion of the electric motor to linear motion of the ball screw mechanism to produce a drive force concerning damping operation and expansion-contraction operation.

Herein, the drive force concerning damping operation means a damping force, which is a force (reaction force) in a direction opposite to the direction of a stroke of the electromagnetic actuator. The drive force concerning expansion-contraction operation means an expansion-contraction force, which is a force in a direction along the direction of expansion or contraction of the electromagnetic actuator. The drive force concerning expansion-contraction operation is a force produced in the same or opposite direction to the stroke direction, independently of the stroke direction.

In order to provide a vehicle with more comfortable ride and more stable steering, it was highly desirable that the electric suspension device according to Patent Literature 1 was prevented from falling into full bump or full rebound.

In order to respond to the request, the electric suspension device according to Patent Literature 1 includes: an electromagnetic actuator which is arranged beside a spring member provided between the body and each wheel of the vehicle and produces a drive force concerning damping operation and expansion-contraction operation; an information acquisition section which acquires the stroke position of the electromagnetic actuator; and an ECU which sets a target damping force and a target expansion-contraction force of the electromagnetic actuator and performs drive control for the electromagnetic actuator using a target drive force based on the target damping force and target expansion-contraction force.

When the stroke position is at an end region around either end of a stroke, the ECU corrects the target drive force so as to move the stroke position from the end region toward a neutral region.

With the electric suspension device according to Patent Literature 1, it is possible to prevent the vehicle traveling under sever conditions from falling into full bump or full rebound.

However, no special consideration is given to the electric suspension device according to Patent Literature 1 in regard to minimizing roll vibration of a vehicle while keeping the vehicle in a substantially horizontal position in situations where the vehicle is traveling along flat curved roads or cross slope roads, for example.

### SUMMARY OF THE INVENTION

The present invention has been made in the light of the aforementioned circumstances and makes it an object thereof to provide an electric suspension device capable of minimizing roll vibration of a vehicle while keeping the vehicle in a substantially horizontal position even in situations where the vehicle is traveling along flat curved roads or cross slope roads.

To implement the aforementioned object, according to a first aspect of the present invention, an electric suspension device includes: an electromagnetic actuator which is arranged in parallel to a spring member provided between a body and a wheel of a vehicle and produces a drive force concerning damping operation and expansion-contraction operation; an information acquisition section which acquires roll velocity of the vehicle; a damping force calculation section which calculates a target damping force as a target value for the damping operation of the electromagnetic actuator; and a drive controller which performs drive control for the electromagnetic actuator using a target drive force based on the target damping force calculated by the damping force calculation section. The damping force calculation section calculates a standard damping force of the electromagnetic actuator as a standard value, calculates a supplementary damping force which supplements the standard damping force based on the roll velocity acquired by the information acquisition section, and adds the calculated standard and supplementary damping forces to calculate the target damping force.

An electric suspension device according to the present invention is capable of minimizing roll vibration of a vehicle while keeping the vehicle in a substantially horizontal position even in situations where the vehicle is traveling along flat curved roads or cross slope roads.

### BRIEF DESCRIPTION OF THE DRAWINGS

FIG. 1 is an entire configuration diagram of an electric suspension device according to the present invention.

FIG. 2 is a partial cross-sectional view of an electromagnetic actuator included in the electric suspension device.

FIG. 3 is a block diagram of the inside of a drive control apparatus included in the electric suspension device and the periphery thereof.

FIG. 4A is a block diagram of a right-side drive control apparatus according to a first embodiment included in the electric suspension device of the present invention.

FIG. 4B is a block diagram of a left-side drive control apparatus according to the first embodiment included in the electric suspension device of the present invention.

FIG. 4C is a diagram for explaining operations of the drive control apparatus according to the first embodiment that reduces roll movement occurring in a vehicle traveling along a curve on a flat road.

FIG. 4D is a diagram for explaining operations of the drive control apparatus according to the first embodiment that reduces roll movement occurring in a vehicle traveling straight on a cross slope road.

FIG. 5A is a block diagram of a right-side drive control apparatus according to a second embodiment included in the electric suspension device of the present invention.

FIG. 5B is a block diagram of a left-side drive control apparatus according to the second embodiment included in the electric suspension device of the present invention.

FIGS. 6A to 6D are diagrams for explaining the operation of the drive control apparatus according to the second embodiment.

FIG. 7A is a block diagram of a right-side drive control apparatus according to a modification of the second embodiment.

FIG. 7B is a block diagram of a left-side drive control apparatus according to the modification of the second embodiment.

### DETAILED DESCRIPTION OF THE EMBODIMENTS

Electric suspension devices according to embodiments of the present invention will be hereinafter described in detail with reference to the accompanying drawings.

In the drawings illustrated below, members including the same functions are given the same reference numerals. Some members are schematically illustrated with the size and shape being modified or exaggerated for convenience of explanation.

### [Brief Description of Electric Suspension Device 11 According to Present Invention]

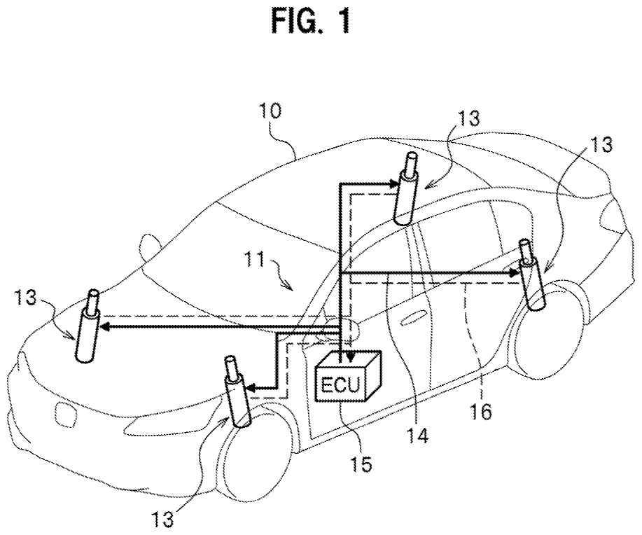

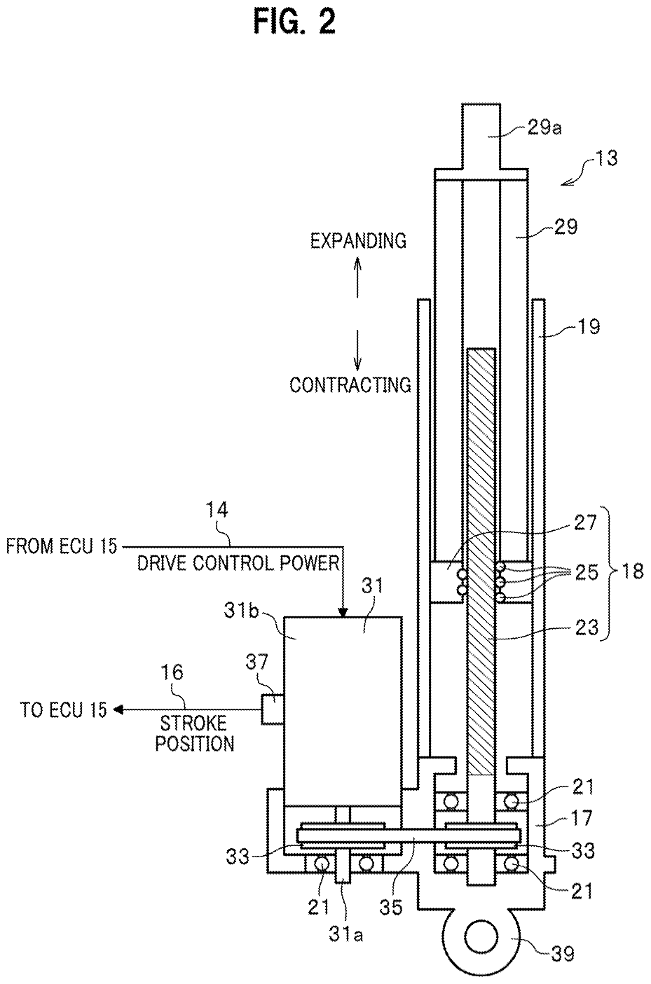

First, brief description of an electric suspension device 11 according to the present invention, which is common to the plural embodiments (the first and second embodiments) of the present invention, will be described with reference to FIGS. 1 and 2.

FIG. 1 is an entire configuration diagram of the electric suspension device 11 according to the present invention. FIG. 2 is a partial cross-sectional view of one of electromagnetic actuators 13, which constitute a part of the electric suspension device 11.

The electric suspension device 11 according to the present invention, as illustrated in FIG. 1, includes: the plurality of electromagnetic actuators 13, which are provided for the respective wheels of a vehicle 10; and an electronic control unit (hereinafter, referred to as an ECU) 15. The plural electromagnetic actuators 13 connect to the ECU 15 through power lines 14 (see solid lines in FIG. 1) and signal lines 16 (see dashed lines in FIG. 1). The power lines 14 supply electric power for drive control, from the ECU 15 to the plural electromagnetic actuators 13. The signal lines 16 transmit stroke positions of the plural electromagnetic actuators 13, from the electromagnetic actuators 13 to the ECU 15.

In the first and second embodiments (described in detail later) of the present invention, the plural electromagnetic actuators 13 include totally four electromagnetic actuators 13 for the respective wheels of the vehicle 10, including front wheels (right and left front wheels) and rear wheels (right and left rear wheels). In the following description, the right front and right rear wheels are sometimes collectively referred to as right wheels, and the left front and left rear wheels are sometimes collectively referred to as left wheels.

The plural electromagnetic actuators 13 include the same configuration in the embodiments. The following paragraphs will describe the configuration of one of the electromagnetic actuators 13, instead of the plural electromagnetic actuators 13.

As illustrated in FIG. 2, the electromagnetic actuator 13 includes a base housing 17, an outer tube 19, ball bearings 21, a ball screw shaft 23, plural balls 25, a nut 27, and an inner tube 29.

The base housing 17 supports the proximal end of the ball screw shaft 23 with the ball bearings 21 interposed therebetween so that the ball screw shaft 23 freely rotate around the axis thereof. The outer tube 19 is provided for the base housing 17 and accommodates a ball screw mechanism 18, which includes the ball screw shaft 23, plural balls 25, and nut 27. The plural balls 25 roll along the thread groove of the ball screw shaft 23. The nut 27 engages with the ball screw shaft 23 with the plural balls 25 interposed therebetween and converts rotary motion of the ball screw shaft 23 into linear motion. The inner tube 29 connected to the nut 27 is displaced along the axis of the outer tube 19 integrally with the nut 27.

To transmit a rotary drive force to the ball screw shaft 23, the electromagnetic actuator 13 includes an electric motor 31, a pair of pulleys 33, and a belt member 35 as illustrated in FIG. 2. The electric motor 31 is provided for the base housing in parallel with the outer tube 19. The pulleys 33 are attached to a motor shaft 31a of the electric motor 31 and the ball screw shaft 23. On the pair of pulleys 33, the belt member 35 is laid to transmit the rotary drive force of the electric motor 31 to the ball screw shaft 23.

A casing 31b of the electric motor 31 is provided with a resolver 37, which detects a rotation angle signal from the electric motor 31. The rotation angle signal of the electric motor 31 detected by the resolver 37 is transmitted to the ECU 15 through one of the signal lines 16. In the embodiments of the present invention, the rotation angle of the electric motor can be replaced with the stroke position of the electromagnetic actuator 13. This is because the stroke position of the electromagnetic actuator 13 is displaced in either a direction of expansion or contraction (see FIG. 2) with a change in the rotation angle of the electric motor 31.

The rotary drive of the electric motor 31 is controlled based on the drive control power which is supplied to each electromagnetic actuator 13 through one of the power lines 14 by the ECU 15.

The first and second embodiments of the present invention employ the layout in which the motor shaft 31a of the electric motor 31 and the ball screw shaft 23 are arranged substantially in parallel and are connected to each other as illustrated in FIG. 2. The dimension of the electromagnetic actuator 13 along the axis is thereby reduced. However, the motor shaft 31a of the electric motor 31 and the ball screw shaft 23 may be coaxially arranged and connected to each other.

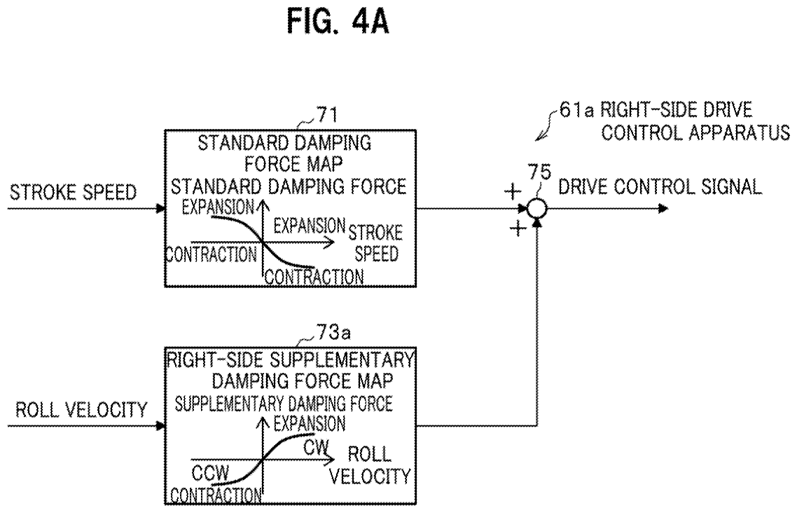

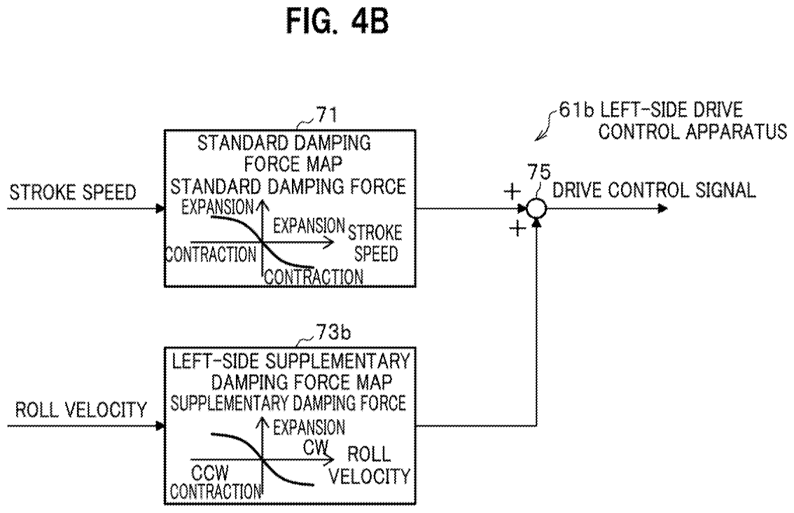

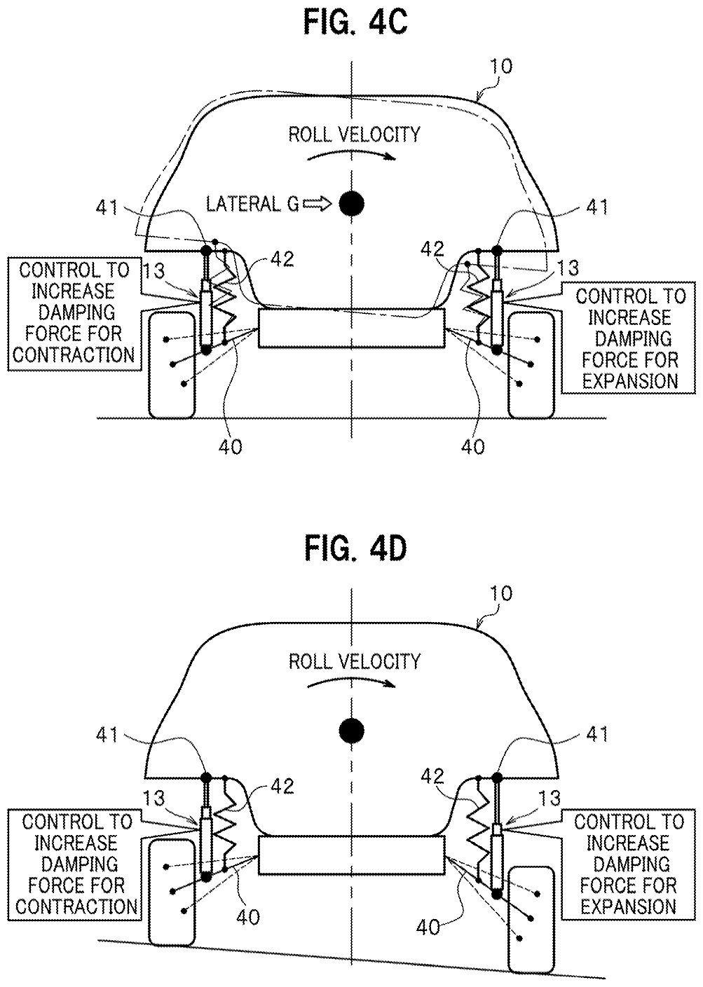

As illustrated in FIG. 2, the electromagnetic actuator 13 according to the present invention includes a connection member 39 at the lower end of the base housing 17. The connection member 39 is coupled and fixed to a lower arm 40 (see FIGS. 4C and 4D) as an unsprung member. An upper end 29a of the inner tube 29 is coupled and fixed to a strut tower 41 (see FIGS. 4C and 4D) of the vehicle body as an sprung member.

In other words, the electromagnetic actuator 13 is arranged in parallel to a spring member 42 provided between the body and a wheel of the vehicle 10. The sprung member is provided with a sprung acceleration sensor 43, which detects acceleration of the vehicle body (a sprung member) along the stroke direction of the electromagnetic actuator 13.

The electromagnetic actuator 13 configured as described above operates as follows. For example, it is assumed that the connection member 39 is subjected to an upward external force concerning vertical vibration from the wheel's side of the vehicle 10. In this case, with respect to the outer tube 19 subjected to the external force concerning vertical vibration, the inner tube 29 and nut 27 are intended to move down integrally. The ball screw shaft 23 is then intended to rotate in a direction corresponding to the downward motion of the nut 27. In this process, the electromagnetic actuator 13 produces a rotary drive force of the electric motor 31 in such a direction as to prevent the nut 27 from moving down. The thus-produced rotary drive force of the electric motor 31 is transmitted to the ball screw shaft 23 through the belt member 35.

In such a manner, the electromagnetic actuator 13 applies a damping force (a force in the direction opposite to the stroke direction), which is a reaction force against the upward external force concerning vertical vibration, to the ball screw shaft 23, thus damping vibration to be transmitted from the wheel side to the body side.

### [Internal Configuration of ECU 15]

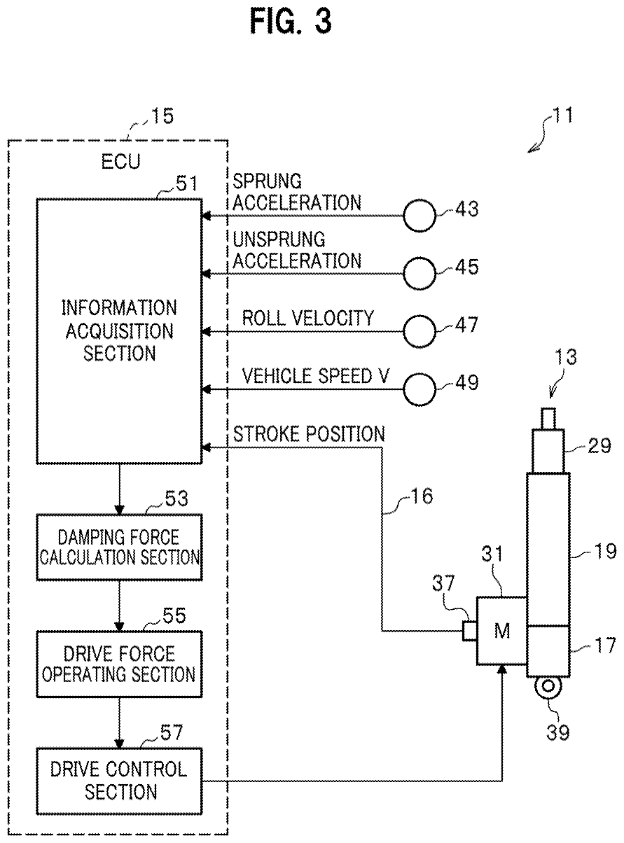

Next, the internal configuration of the ECU 15 as a drive control apparatus included in the electric suspension device 11 will be described with reference to FIG. 3. FIG. 3 is a block diagram of the inside of the drive control apparatus (ECU 15) included in the electric suspension device 11 and the periphery thereof.

The ECU 15 includes a microcomputer performing various types of arithmetic processing. The ECU 15 includes a drive control function to produce a drive force concerning damping operation and expansion-contraction operation by individually performing drive control for each of the electromagnetic actuators 13 based on the rotation angle of the electric motor 31 detected by the resolver 37, that is, the stroke position of the electromagnetic actuator 13 or the like. The ECU 15 corresponds to a drive controller of the present invention.

To implement the aforementioned drive control function, the ECU 15 includes an information acquisition section 51, a damping force calculation section 53, a drive force operating section 55, and a drive control section 57 as illustrated in FIG. 3.

The information acquisition section 51 acquires information on the rotation angle of each electric motor 31 detected by the resolver 37, that is, the stroke position of each electromagnetic actuator 13. The information acquisition section 51 also acquires information on the sprung acceleration detected by the sprung acceleration sensor 43, unsprung acceleration detected by an unsprung acceleration senor 45, the roll velocity detected by a roll velocity sensor 47, and vehicle speed V detected by a vehicle speed sensor 49.

The information acquisition section 51 further calculates the stroke speed of each electromagnetic actuator 13 (hereinafter, sometimes just referred to as stroke speed) by differentiating the displacement of the stroke position of the electromagnetic actuator 13 with respect to time. The stroke speed of the electromagnetic actuator 13 includes both the stroke speed and stroke direction. Vehicle condition information including the stroke speed of the electromagnetic actuator 13, sprung acceleration, unsprung acceleration, roll velocity, and vehicle speed V acquired by the information acquisition section 51 is transmitted to the damping force calculation section 53.

The damping force calculation section 53 calculates a target damping force as the target value for damping operation of each electromagnetic actuator 13, based on the vehicle condition information acquired by the information acquisition section 51. The information on the target damping force calculated by the damping force calculation section 53 is transmitted to the drive force operating section 55. The specific calculation of the damping force calculation section 53 is described in detail later.

The drive force operating section 55 receives the information on the stroke speed and roll velocity and generates a damping force control signal and an expansion-contraction force control signal with reference to the received information, a standard damping force map 71, a supplementary damping force map 73, a roll-angle-reducing spring control force map 79, and the like. These maps will be described later. The drive force operating section 55 further merges the generated damping force control signal and expansion-contraction force control signal to calculate a drive control signal including a target drive force. The drive control signal including the target drive force, as the result of calculation by the drive force operating section 55, is transmitted to the drive control section 57. The specific operation by the drive force operating section 55 will be described in detail later.

The drive control section 57 supplies drive control power to the electric motor 31 provided for each of the plural electromagnetic actuators 13 according to the drive control signal transmitted from the drive force operating section 55, thus independently performing drive control for the plural electromagnetic actuators 13. The process of generating the drive control power to be supplied to the electric motor 31 preferably uses an inverter control circuit, for example.

### [Block Configuration of Drive Control Apparatus 61 According to First Embodiment]

Next, the block configuration of a drive control apparatus 61 according to the first embodiment included in the electric suspension device 11 of the present invention will be described with reference to FIGS. 4A and 4B. FIG. 4A is a block diagram of a right-side drive control apparatus 61a according to the first embodiment. FIG. 4B is a block diagram of a left-side drive control apparatus 61b according to the first embodiment.

The drive control apparatus 61 according to the first embodiment includes: the right-side drive control apparatus 61a which is included in the electric suspension device 11 provided for right wheels of the vehicle 10; and the left-side drive control apparatus 61b which is included in the electric suspension device 11 provided for left wheels of the vehicle 10.

The right-side drive control apparatus 61a and the left-side drive control apparatus 61b include some identical constituent members, which are a standard damping force map 71 and a first adder 75. For explanation of the configuration of the left-side drive control apparatus 61b, only the constituent component (a left-side supplementary damping force map 73b) other than the identical constituent members will be described.

The right-side drive control apparatus 61a according to the first embodiment includes the standard damping force map 71, a right-side supplementary damping force map 73a, and the first adder 75 as illustrated in FIG. 4A.

The left-side drive control apparatus 61b according to the first embodiment includes the standard damping force map 71, a left-side supplementary damping force map 73b, and the first adder 75 as illustrated in FIG. 4B.

In the description of the specification, the right-side drive control apparatus 61a and the left-side drive control apparatus 61b are collectively referred to as the drive control apparatus 61 when needed. The right-side supplementary damping force map 73a and the left-side supplementary damping force map 73b are collectively referred to as supplementary damping force maps 73 when needed.

As illustrated in FIGS. 4A and 4B, each standard damping force map 71 stores a standard value of the damping force which changes with the stroke speed. The standard value of the damping force is actually stored as a standard value of damping force control current.

In the examples illustrated in FIGS. 4A and 4B, the standard damping force map 71 is configured to include such a characteristic that the damping force for contraction increases with the stroke speed for expansion while the damping force for expansion increases with the stroke speed for contraction. This characteristic follows the characteristic of conventional hydraulic dampers. When the stroke speed is zero, the damping force corresponding thereto is zero.

In the drive control apparatus 61 according to the first embodiment, with reference to the stroke speed of the electromagnetic actuator 13 acquired by the information acquisition section 51 and the stored information on the standard damping force map 71, the standard value of damping force corresponding to the inputted stroke speed is calculated.

Each of the supplementary damping force maps 73 illustrated in FIGS. 4A and 4B stores a supplementary value of the damping force which changes with the roll velocity so as to suit to the electric suspension device 11 provided for right or left wheels. The supplementary value of the damping force plays a role in supplementing the standard value of the damping force, which is properly calculated based on stroke speed, in order that the damping force accommodates changes in the roll velocity. The supplementary value of the damping force is actually stored as a supplementary value of damping force control current.

The right-side supplementary damping force map 73a illustrated in FIG. 4A is configured to include a right-side supplementary damping force characteristic in which the damping force for expansion increases with the roll velocity occurring clockwise (in the CW (right) direction) as viewed from behind in the direction of travel while the damping force for contraction increases with the roll velocity occurring counterclockwise (in the CCW (left) direction) as viewed from behind in the direction of travel.

The left-side supplementary damping force map 73b illustrated in FIG. 4B is configured to include a left-side supplementary damping force characteristic in which the damping force for contraction increases with the roll velocity occurring clockwise (in the CW (right) direction) as viewed from behind in the direction of travel while the damping force for expansion increases as the roll velocity occurring counterclockwise (in the CCW (left) direction) as viewed from behind in the direction of travel.

In both the right-side supplementary damping force characteristic and the left-side supplementary damping force characteristic, when the roll velocity is zero, the supplementary damping force corresponding thereto is zero.

The left-side supplementary damping force characteristic is configured so that the direction of the damping force is set to the inverse of that of the right-side supplementary damping force characteristic for the following reason. When the roll velocity occurs clockwise (in the CW (right) direction) as viewed from behind in the direction of travel, the spring member provided between the body and each right wheel of the vehicle 10 is subjected to a contraction force while the spring member provided between the body and each left wheel of the vehicle 10 is subjected to an expansion force.

In order to minimize roll vibration of the vehicle 10 in such a case, the damping force is applied in the direction opposite to the direction of the roll velocity. Specifically, when the roll velocity occurs clockwise (in the CW (right) direction) as viewed from behind in the direction of travel, the damping force for expansion is applied to the spring member provided between the body and each right wheel of the vehicle 10 while the damping force for contraction is applied to the spring member between the body and each left wheel of the vehicle 10. This minimizes roll vibration of the vehicle 10 and keeps the vehicle 10 in a substantially horizontal position.

### [Description of Operation of Drive Control Apparatus 61 According to First Embodiment]

Next, operations of the drive control apparatus 61 according to the first embodiment will be described with reference to FIGS. 4C and 4D. FIG. 4C is a diagram for explaining operations of the drive control apparatus 61 according to the first embodiment which reduces roll movement of a vehicle 10 traveling along a curve on a flat road. FIG. 4D is a diagram for explaining operations of the drive control apparatuses 61 according to the first embodiment which reduces roll movement of a vehicle 10 traveling straight on a cross slope road.

Among the operations of the drive control apparatus 61 according to the first embodiment, first, operations common to a first travel situation where the vehicle 10 is traveling along a flat, curved road and a second travel situation where the vehicle 10 is traveling straight on a cross slope road.

The first adder 75 of the drive control apparatus 61 according to the first embodiment adds the standard value of the damping force calculated with reference to the stroke speed and standard damping force map 71 and the supplementary value of the damping force calculated with reference to the roll velocity and supplementary damping force map 73, to generate a drive control signal including a target drive force which is the combination of the standard damping force and supplementary damping force. The thus-generated drive control signal including the target drive force is transmitted to the drive control section 57. Upon receiving the target drive force, the drive control section 57 then performs drive control for the plural electromagnetic actuators 13.

<Operation in First Travel Situation where Vehicle 10 is Traveling Along Flat Curved Road>

Next, among the operations of the drive control apparatus 61 according to the first embodiment, operations in the first travel situation, where the vehicle 10 is traveling along a flat, curved road, will be described with reference to FIG. 4C.

In the first travel situation, where the vehicle 10 is traveling along a flat, curved road, it is assumed that the roll velocity occurs clockwise (in the CW (right) direction) as viewed in the direction of travel. In this case, if no countermeasure is taken to reduce roll unlike the present invention, the vehicle 10 leans clockwise (toward the right) viewed from behind in a roll, as illustrated by a dashed-dotted line in FIG. 4D.

When the roll velocity occurs clockwise (in the CW (right) direction) in the first situation, where the vehicle 10 is traveling along a flat, curved road, the right-side drive control apparatus 61a of the drive control apparatus 61 according to the first embodiment performs damping force control so that the damping force for expansion increases with the roll velocity occurring clockwise (in the CW (right) direction).

In the same situation as described above, the left-side drive control apparatus 61b of the drive control apparatuses 61 according to the first embodiment performs damping force control so that the damping force for contraction increases with the roll velocity occurring clockwise (in the CW (right) direction).

With the drive control apparatuses 61 according to the first embodiment, when the roll velocity occurs clockwise (in the CW (right) direction) in the first situation, where the vehicle 10 is traveling along a flat, curved road, damping force control is performed to increase the damping force for expansion in the right-side electromagnetic actuators 13 while damping force control is performed to increase the damping force for contraction in the left-side electromagnetic actuators 13. It is therefore possible to minimize roll vibration of the vehicle 10 and keeps the vehicle 10 in a substantially horizontal position even in a situation where the vehicle 10 is traveling along a flat, curved road.

<Operation in Second Travel Situation where Vehicle 10 is Traveling Straight, Moving from Flat Road to Cross Slope Road>

Next, among operations of the drive control apparatus 61 according to the first embodiment, operations in the second travel situation where the vehicle 10 is traveling straight as moving from a flat road to a cross slope road (canted road on which the vehicle 10 leans toward the right as viewed from behind in the example of FIG. 4D) will be described with reference to FIG. 4D.

In the second travel situation, where the vehicle 10 is traveling straight as moving from a flat road to a cross slope road, if no countermeasure is taken to reduce roll unlike the present invention, the vehicle 10 leans toward the right following the gradient of the canted road into a roll.

In the second situation, where the vehicle 10 is traveling straight as moving from a flat road to a cross slope road, the right-side drive control apparatus 61a of the drive control apparatus 61 according to the first embodiment performs expansion-contraction force control so that the expansion-contraction force for expansion increases with the roll velocity occurring clockwise (in the CW (right) direction).

In the same situation as described above, the left-side drive control apparatus 61b of the drive control apparatus 61 according to the first embodiment performs expansion-contraction force control so that the expansion-contraction force for contraction increases with the roll velocity occurring clockwise (in the CW (right) direction).

With the drive control apparatus 61 according to the first embodiment, when the roll velocity occurs clockwise (in the CW (right) direction) in the second situation, where the vehicle 10 is traveling straight as moving from a flat road to a cross slope road, expansion-contraction force control is performed to increase the expansion-contraction force for expansion in the right-side electromagnetic actuators 13 while expansion-contraction force control is performed to increase the expansion-contraction force for contraction in the left-side electromagnetic actuators 13. It is therefore possible to minimize roll vibration of the vehicle 10 and keep the vehicle 10 in a substantially horizontal position even in the situation where the vehicle 10 is traveling straight as moving from a flat road to a cross slope road.

Whether the vehicle 10 is in the first travel situation, where the vehicle 10 is traveling along a flat, curved road, or in the second travel situation, where the vehicle 10 is traveling straight as moving from a flat road to a cross slope road, may be determined by capturing images of the view ahead of the vehicle 10 with a camera (not illustrated) mounted on the vehicle 10 and performing necessary image processing for the captured images.

### [Block Configuration of Drive Control Apparatus 63 According to Second Embodiment]

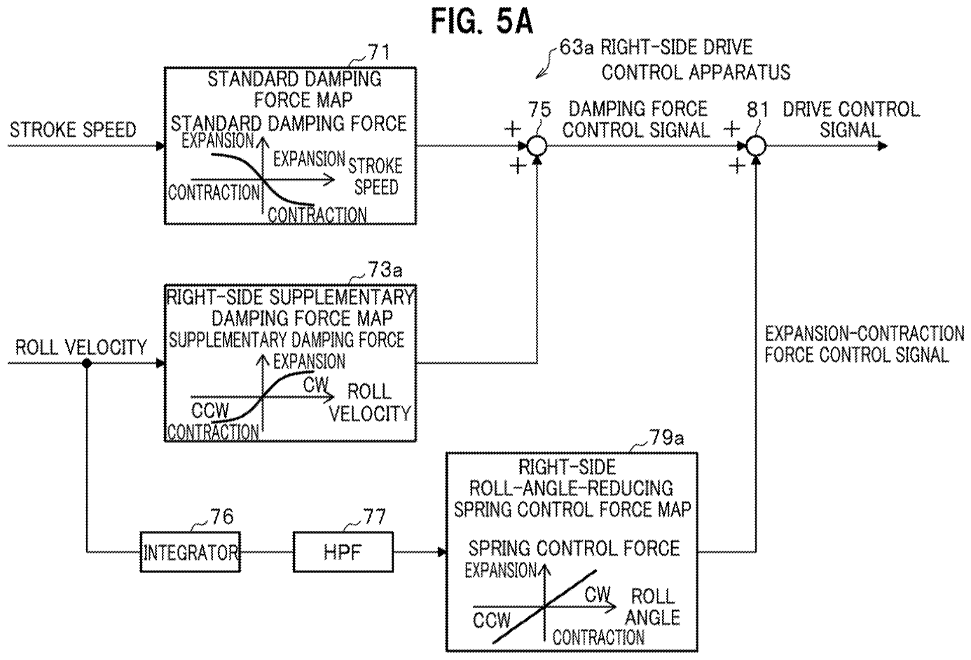

Next, the block configuration of a drive control apparatus 63 according to the second embodiment included in the electric suspension device 11 of the present invention will be described with reference to FIGS. 5A and 5B. FIG. 5A is a block diagram of a right-side drive control apparatus 63a according to the second embodiment. FIG. 5B is a block diagram of a left-side drive control apparatus 63b according to the second embodiment.

The drive control apparatus 63 according to the second embodiment includes some different constituent members in addition to the constituent members of the drive control apparatus 61 according to the first embodiment. The additional constituent members are an integrator 76, a high-pass filter (HPF) 77, a roll-angle-reducing spring control force map 79, and a second adder 81. For explanation of the configuration of the drive control apparatus 63 according to the second embodiment, the additional constituent members will be mainly described.

The drive control apparatus 63 according to the second embodiment includes: the right-side drive control apparatus 63a which is included in the electric suspension device 11 provided for right wheels of the vehicle 10; and the left-side drive control apparatus 63b which is included in the electric suspension device 11 provided for left wheels of the vehicle 10.

The right-side drive control apparatus 63a and the left-side drive control apparatus 63b include some identical constituent members, which are the standard damping force map 71, supplementary damping force map 73, and first adder 75. For explanation of the configuration of the left-side drive control apparatus 63b, the constituent components other than the identical constituent members will be mainly described.

As illustrated in FIG. 5A, the right-side drive control apparatus 63a according to the second embodiment includes the integrator 76, the high-pass filter (HPF) 77, a right-side roll-angle-reducing spring control force map 79a, and the second adder 81, in addition to the standard damping force map 71, right-side supplementary damping force map 73a, and first adder 75, which constitute the right-side drive control apparatus 61a according to the first embodiment.

As illustrated in FIG. 5B, the left-side drive control apparatus 63b according to the second embodiment includes the integrator 76, the high-pass filter (HPF) 77, a left-side roll-angle-reducing spring control force map 79b, and the second adder 81, in addition to the standard damping force map 71, right-side supplementary damping force map 73b, and first adder 75, which constitute the left-side drive control apparatus 61b according to the first embodiment.

In the description of the specification, the right-side drive control apparatus 63a and the left-side drive control apparatus 63b are collectively referred to as the drive control apparatus 63 when needed. The right-side roll-angle-reducing spring control force map 79a and the left-side roll-angle-reducing spring control force map 79b are collectively referred to as the roll-angle-reducing spring control force map 79 when needed.

The integrator 76 integrates time-series information concerning the roll velocity acquired by the information acquisition section 51 with respect to time to output time-series information concerning the roll angle of the vehicle 10. The time-series information concerning the roll angle of the vehicle 10 outputted from the integrator 76 is inputted to the high-pass filter (HPF) 77.

The HPF 77 performs high-pass filtering that passes high-frequency components, for the time-series information concerning the roll angle of the vehicle 10 outputted from the integrator 76, thus eliminating trend included in the time-series information concerning the roll angle of the vehicle 10. The time-series information concerning the roll angle of the vehicle 10 with the trend eliminated, which is outputted from the HPF 77, is used to calculate a right-side roll-angle-reducing spring control force with reference to the right-side roll-angle-reducing spring control force map 79a.

The cutoff frequency of the HPF 77 is properly determined to a frequency (about 0.1 to 0.5 Hz, for example) equal to or lower than the lowest frequency (0.5 Hz) in a range of frequencies (0.5 to 20 Hz) to which human bodies are highly sensitive. The cutoff frequency of the HPF 77 may be a fixed value or a variable value.

The trend intended to be eliminated by the HPF 77 is a steady trend due to the vehicle 10 maintaining a certain roll angle in a given situation where the vehicle 10 is traveling along a cross slope road, such as a banked road, for example. The intent of providing the HPF 77 will be described later in detail.

Each of the roll-angle-reducing spring control force maps 79 illustrated in FIGS. 5A and 5B stores a roll-angle-reducing spring control force which changes with the roll angle so as to suit to the electric suspension device 11 provided for right or left wheels. The roll-angle-reducing spring control force plays a role in correcting the spring control force set as an expansion-contraction force of the electromagnetic actuator 13 in response to changes in the roll angle of the vehicle 10 in the light of reducing the roll angle. The roll-angle-reducing spring control force is actually stored as a correction value of spring control force control current.

The right-side roll-angle-reducing spring control force maps 79a illustrated in FIG. 5A is configured to include a linear right-side roll-angle-reducing spring control force characteristic in which the spring control force for expansion increases with the roll angle measured clockwise (in the CW (right) direction) as viewed from behind in the direction of travel while the spring control force for contraction increases with the roll angle measured counterclockwise (in the CCW (left) direction) as viewed from behind in the direction of travel.

The left-side roll-angle-reducing spring control force map 79b illustrated in FIG. 5B is configured to include a linear left-side roll-angle-reducing control force characteristic in which the spring control force for contraction increases with the roll angle measured clockwise (in the CW (right) direction) as viewed from behind in the direction of travel while the spring control force for expansion increases with the roll angle measured counterclockwise (in the CCW (left) direction) as viewed from behind in the direction of travel.

In both the right-side roll-angle-reducing spring control force characteristic and the left-side roll-angle-reducing spring control force characteristic, when the roll angle is zero, the spring control force corresponding thereto is zero.

In the left-side roll-angle-reducing spring control force characteristic, the directions of expansion and contraction are set to the inverse of those in the right-side roll-angle-reducing spring control force characteristic for the following reason. When the roll direction (the roll angle) is clockwise (in the CW (right) direction) as viewed from behind in the direction of travel, the spring member provided between the body and each right wheel of the vehicle 10 is subjected to a contraction force while the spring member provided between the body and each left wheel of the vehicle 10 is subjected to an expansion force.

In order to keep the vehicle 10 in a substantially horizontal position in the aforementioned situation, the spring control force is applied so as to turn the vehicle 10 in the direction opposite to the roll direction. Specifically, when the roll direction (the roll angle) is clockwise (in the CW (right) direction) as viewed from behind in the direction of travel, the spring control force for expansion is applied to the spring member between the body and each right wheel of the vehicle 10 while the spring control force for contraction is applied to the spring member between the body and each left wheel of the vehicle 10. This keeps the vehicle 10 in a substantially horizontal position.

Next, operations of the drive control apparatus 63 according to the second embodiment will be described.

In the drive control apparatus 63 according to the second embodiment, the first adder 75 adds the standard value of the damping force calculated with reference to the stroke speed and standard damping force map 71 and the supplementary value of the damping force calculated with reference to the roll velocity and supplementary damping force map 73 to generate a damping force control signal as the combination of the standard damping force and supplementary damping force. The thus-generated damping force control signal is transmitted to the second adder 81.

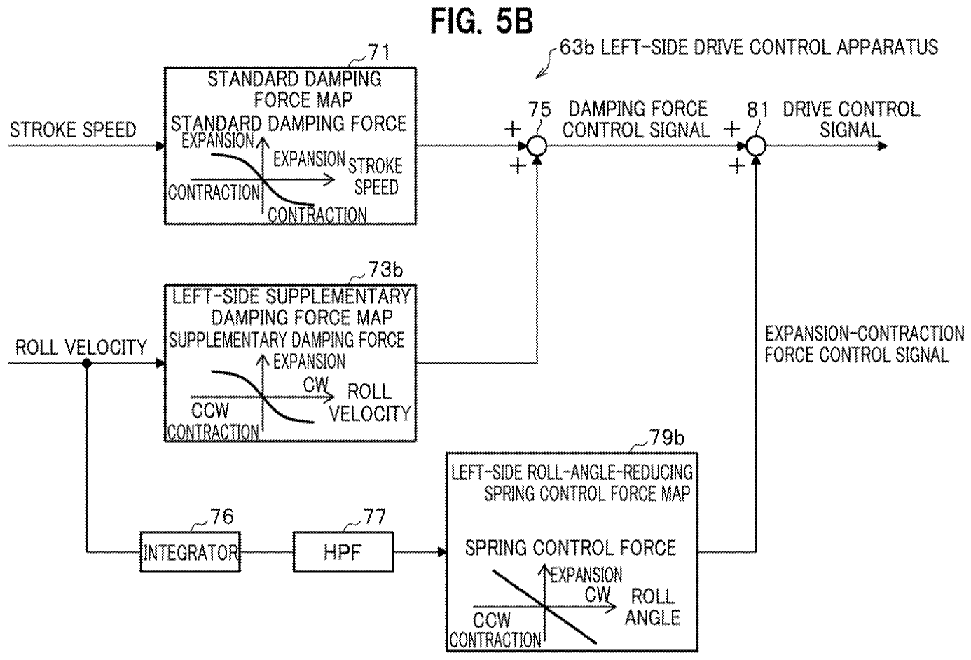

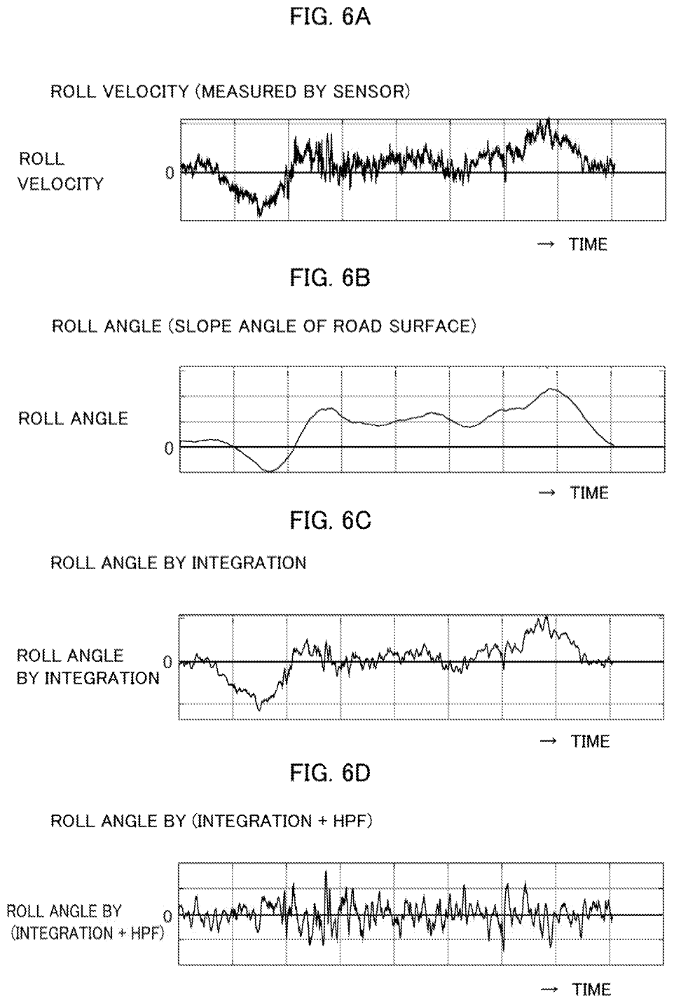

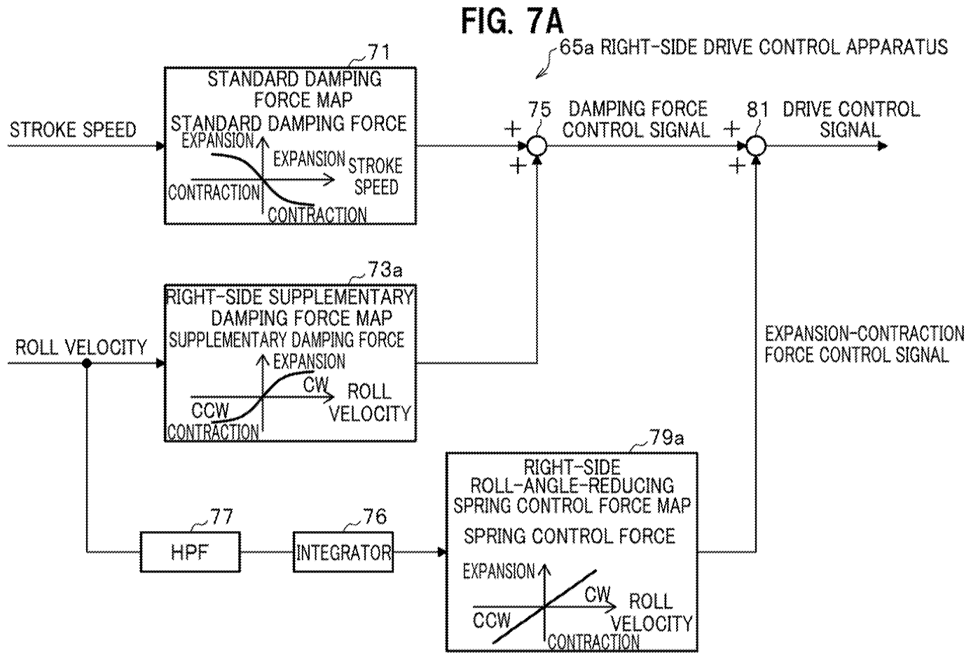

In order to keep the vehicle 10 in a substantially horizontal position, the drive control apparatus 63 according to the second embodiment performs the following operations. FIGS. 6A to 6D are diagrams for explaining the operations of the drive control apparatus 63 according to the second embodiment.

In the drive control apparatus 63 according to the second embodiment, the integrator 76 integrates time-series information concerning the roll velocity acquired by the information acquisition section 51 (see FIG. 6A), with respect to time to output time-series information concerning the roll angle of the vehicle 10 (see FIG. 6C). FIG. 6B illustrates the time-series information concerning the roll angle of the vehicle 10 (the angle of the cross slope of the road). FIGS. 6A to 6D show that the time-series information concerning the roll angle of the vehicle 10 (see FIG. 6C) which is acquired by time-integration of the time-series information concerning the roll velocity highly correlates with the time-series information concerning the roll angle of the vehicle 10 (the angle of the cross slope of the road, FIG. 6B). In other words, the vehicle 10 is positioned at a roll angle following the angle of the cross slope of the road.

The HPF 77 performs high-pass filtering to pass high-frequency components, for the time-series information concerning the roll angle of the vehicle 10 outputted from the integrator 76, thus eliminating the trend included in the time-series information concerning the roll angle of the vehicle 10. FIG. 6D illustrates the time-series information concerning the roll angle of the vehicle 10 with the trend eliminated. The origin 0 of FIG. 6D represents a reference value of the roll angle of the vehicle 10. The reference value of the roll angle provides a reference to reduce roll vibration of the vehicle 10 and is not always the value of the roll angle when the vehicle 10 is positioned horizontally.

The drive control apparatus 63 calculates a spring control force that can suitably reduce the roll angle of the vehicle 10, based on the time-series information concerning the roll angle of the vehicle 10 with the trend eliminated (see FIG. 6D), which is outputted from the HPF 77, and the roll-angle-reducing spring control force map 79. The drive control apparatus 63 then generates an expansion-contraction force control signal able to implement the calculated spring control force. The thus-generated expansion-contraction force control signal is transmitted to the second adder 81.

The second adder 81 merges: the damping force control signal which is generated by the first adder 75 as the combination of the standard damping force and supplementary damping force; and the expansion-contraction force control signal to implement a spring control force capable of reducing the roll angle of the vehicle 10, to generate a drive control signal including a target drive force. The thus-generated drive control signal including the target drive force is transmitted to the drive control section 57. Upon receiving the drive control signal, the drive control section 57 performs drive control for the plural electromagnetic actuators 13.

Herein, the intent of providing the HPF 77 will be described. The trend intended to be eliminated by the HPF 77 is a steady trend (low-frequency components of the roll angle) due to the vehicle 10 maintaining a certain roll angle in a situation where the vehicle 10 is traveling along a cross slope road, such as a banked road, for example. Elimination of the trend by the HPF 77 means that the HPF 77 eliminates low-frequency components (with a cutoff frequency of about 0.5 Hz, for example) from the time-series signal of the roll angle to eliminate a steady trend from the time-series information concerning the roll angle.

It is assumed that the vehicle 10 is traveling along a cross slope road while maintaining a certain roll angle. In such a travel situation, it is also assumed that another drive control apparatus not including the HPF 77 is operated, in contrast with the drive control apparatus 63 including the HPF 77.

In the aforementioned travel situation, with the drive control apparatus not including the HPF 77, the range of changes (the dynamic range) in the roll angle of the vehicle 10 (see FIG. 6C), as the output of the integrator 76, which integrates the time-series information concerning the roll angle with respect to time, is greater than that with the drive control apparatus 63 including the HPF 77 (see FIG. 6D).

The drive control apparatus 63 including the HPF 77 performs the control to reduce roll vibration with less power consumption than the drive control apparatus not including the HPF 77 when the effects in reducing roll vibration are the same. In other words, at the same power consumption concerning roll vibration reduction control, the drive control apparatus 63 including the HPF 77 provides a higher effect in reducing roll vibration in a range of frequencies to which human bodies are highly sensitive, than the drive control apparatus not including the HPF 77.

With the drive control apparatus 63 according to the second embodiment, it is possible to minimize roll vibration of the vehicle 10 while keeping the vehicle 10 in a substantially horizontal position even in a situation where the vehicle 10 is traveling along a flat, curved road or a cross slope road.

### [Block Configuration of Drive Control Apparatus 65 According to Modification of Second Embodiment]

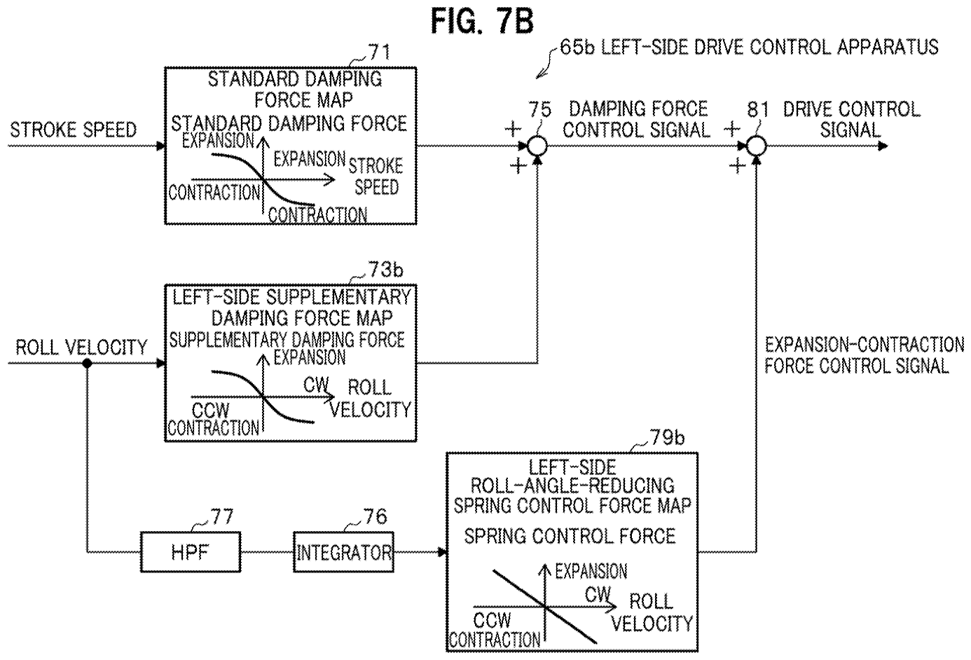

Next, the block configuration of a drive control apparatus 65 according to a modification of the second embodiment included in the electric suspension device 11 of the present invention will be described with reference to FIGS. 7A and 7B. FIG. 7A is a block diagram of a right-side drive control apparatus 65a according to the modification of the second embodiment. FIG. 7B is a block diagram of a left-side drive control apparatus 65b according to the modification of the second embodiment.

The drive control apparatus 65 according to the modification of the second embodiment differs from the drive control apparatus 63 according to the modification of the second embodiment in the order of arrangement of the integrator 76 and HPF 77, which are provided before the roll-angle-reducing spring control force map 79 and perform pre-processing for a time-series signal of the roll velocity.

In the drive control apparatuses 63 according to the second embodiment, the integrator 76 and HPF 77 are arranged in this order (see FIG. 7A). In the drive control apparatuses 65 according to the modification of the second embodiment, the HPF 77 and integrator 76 are arranged in this order (in reverse order of that of the second embodiment, see FIG. 7B). The other configurations of the drive control apparatus 65 according to the modification of the second embodiment are the same as those of the drive control apparatus 63 according to the second embodiment.

Next, operations of the drive control apparatus 65 according to the modification of the second embodiment will be described in contrast with the operation of the drive control apparatus 63 according to the second embodiment.

The drive control apparatus 63 according to the second embodiment integrates the information concerning the roll velocity acquired by the information acquisition section 51, with respect to time by the integrator 76 to calculate the information concerning the roll angle of the vehicle 10; applies the HPF 77, which eliminates a trend, to the calculated information concerning the roll angle to acquire information concerning the roll angle with the trend eliminated; sets a target spring control force of the electromagnetic actuator 13 based on the acquired information concerning the roll angle; and corrects the target drive force by using the set target spring control force so as to reduce the roll angle of the vehicle 10.

On the other hand, the drive control apparatus 65 according to the modification of the second embodiment applies the HPF 77, which eliminates a trend, to the information concerning the roll velocity acquired by the information acquisition section 51 to acquire information concerning the roll velocity with the trend eliminated; integrates the acquired information concerning the roll velocity with respect to time by the integrator 76 to calculate information concerning the roll angle of the vehicle 10; sets a target spring control force of the electromagnetic actuator 13 based on the calculated information concerning the roll angle; and corrects the target drive force by using the set target spring control force so as to reduce the roll angle of the vehicle 10.

With the drive control apparatus 65 according to the modification of the second embodiment, similarly to the drive control apparatus 63 according to the second embodiment, it is possible to minimize roll vibration of the vehicle 10 and keeps the vehicle 10 in a substantially horizontal position even in a situation where the vehicle 10 is traveling along a flat, curved road or a cross slope road.

### [Operation Effect of Electric Suspension Device 11 According to Present Invention]

Next, the operation effects of the electric suspension device 11 according to the present invention will be described.

The electric suspension device 11 based on a first aspect includes: the electromagnetic actuators 13, each of which is arranged in parallel to a spring member provided between the body and a wheel of the vehicle 10 and produces a drive force concerning damping operation and expansion-contraction operation; the information acquisition section 51, which acquires the roll velocity of the vehicle 10; the damping force calculation section 53, which calculates a target damping force as a target value for the damping operation of the electromagnetic actuator 13; and the ECU (drive control apparatus, drive controller) 15, which performs drive control for the electromagnetic actuator 13 using the target drive force based on the target damping force calculated by the damping force calculation section 53. The damping force calculation section 53 calculates a standard damping force of the electromagnetic actuator 13 as the standard and calculates a supplementary damping force which supplements the standard damping force based on the roll velocity acquired by the information acquisition section 51. The damping force calculation section 53 adds the calculated standard and supplementary damping forces to calculate a target damping force.

In the electric suspension device 11 based on the first aspect, the damping force calculation section 53 calculates the target damping force by calculating the standard damping force of the electromagnetic actuator 13 as the standard; calculating the supplementary damping force, which supplements the standard damping force, based on the roll velocity acquired by the information acquisition section 51; and adding the calculated standard and supplementary damping forces. The ECU 15 performs drive control for the electromagnetic actuator 13 using the target drive force based on the target damping force calculated by the damping force calculation section 53.

With the electric suspension device 11 based on the first aspect, the ECU 15 calculates the supplementary damping force, which supplements the standard damping force, based on the roll velocity and adds the standard and supplementary damping forces to calculate the target damping force. The ECU 15 then performs drive control for the electromagnetic actuator 13 using the target drive force based on the calculated target damping force. It is therefore possible to minimize roll vibration of the vehicle 10 while keeping the vehicle 10 in a substantially horizontal position even in a situation where the vehicle 10 is traveling along a flat, curved road or a cross slope road.

The electric suspension device 11 based on a second aspect includes: the electromagnetic actuator 13, each of which is arranged in parallel to a spring member provided between the body and a wheel of the vehicle 10 and produces a drive force concerning damping operation and expansion-contraction operation; the information acquisition section 51, which acquires the stroke speed of the electromagnetic actuator 13 and the roll velocity of the vehicle 10; the damping force calculation section 53, which calculates a standard damping force of the electromagnetic actuator 13 as the standard based on the stroke speed acquired by the information acquisition section 51 and calculates a supplementary damping force that supplements the standard damping force, based on the roll velocity acquired by the information acquisition section 51; and the ECU (drive control apparatus, drive controller) 15, which sets the sum of the standard damping force and supplementary damping force calculated in the damping force calculation section 53 as a target damping force which is the target value for damping operation of the electromagnetic actuator 13, sets a target expansion-contraction force which is the target value for expansion-contraction operation of the electromagnetic actuator 13, and performs drive control for the electromagnetic actuator 13 using a target drive force based on the set target damping force and target expansion-contraction force.

In the electric suspension device 11 based on the second aspect, the damping force calculation section 53 calculates the standard damping force of the electromagnetic actuator 13 as the standard based on the stroke speed and calculates the supplementary damping force, which supplements the standard damping force, based on the roll velocity. The ECU 15 sets the sum of the standard and supplementary damping forces as the target damping force, which is the target value for damping operation of the electromagnetic actuator 13 and sets the target expansion-contraction force as the target value for expansion-contraction operation of the electromagnetic actuator 13. The ECU 15 performs drive control for the electromagnetic actuator 13 using the target drive force based on the set target damping force and target expansion-contraction force.

With the electric suspension device 11 based on the second aspect, the ECU 15 sets the sum of the standard and supplementary damping forces as the target damping force, which is the target value for damping operation of the electromagnetic actuator 13, and sets the target expansion-contraction force as the target value for expansion-contraction operation of the electromagnetic actuator 13. The ECU 15 then performs drive control for the electromagnetic actuator 13 using the target drive force based on the set target damping force and target expansion-contraction force. It is therefore possible to minimize roll vibration of the vehicle 10 while keeping the vehicle 10 in a substantially horizontal position even in a situation where the vehicle 10 is traveling along a flat, curved road or a cross slope road.

The electric suspension device 11 based on a third aspect is the electric suspension device 11 based on the second aspect, in which the ECU (drive control apparatus, drive controller) 15 integrates the information concerning the roll velocity acquired by the information acquisition section 51, with respect to time to calculate the information concerning the roll angle of the vehicle 10. Furthermore, the ECU 15 sets a target spring control force of the electromagnetic actuator 13 based on the calculated information concerning the roll angle and by using the set target spring control force, corrects the target drive force so as to reduce the roll angle of the vehicle 10.

With the electric suspension device 11 based on the third aspect, the ECU 15 calculates the information concerning the roll angle of the vehicle 10 by integrating the information concerning the roll velocity with respect to time and sets the target spring control force of the electromagnetic actuator 13 based on the calculated information concerning the roll angle. By using the set target spring control force, the ECU 15 corrects the target drive force so as to reduce the roll angle of the vehicle 10. It is therefore possible to minimize roll vibration of the vehicle 10 while keeping the vehicle 10 in a substantially horizontal position even in a situation where the vehicle 10 is traveling along a flat, curved road or a cross slope road.

The electric suspension device 11 based on a fourth aspect is the electric suspension device 11 based on the third aspect, in which the ECU (drive control apparatus, drive controller) 15 applies the high-pass filter (HPF) 77, which eliminates a trend, to the calculated information concerning the roll angle to acquire the information concerning the roll angle with the trend eliminated. The ECU 15 then sets the target spring control force of the electromagnetic actuator 13 based on the acquired information concerning the roll angle and using the set target spring control force, corrects the target drive force so as to reduce the roll angle of the vehicle 10.

With the electric suspension device 11 based on the fourth aspect, in addition to the effect in minimizing roll vibration of the vehicle 10 while keeping the vehicle 10 in a substantially horizontal position even in a situation where the vehicle 10 is traveling along a flat, curved road or a cross slope road, it is possible to reduce the power consumption due to the control to reduce roll vibration and improve the effect in reducing roll vibration in a range of frequencies to which human bodies are highly sensitive.

The electric suspension device 11 based on a fifth aspect is the electric suspension device 11 based on the second aspect, in which the ECU (drive control apparatus, drive controller) 15 applies the high-pass filter (HPF) 77, which eliminates a trend, to the information concerning the roll velocity acquired by the information acquisition section 51 to acquire the information concerning the roll velocity with the trend eliminated. The ECU 15 then integrates the acquired information concerning the roll velocity with respect to time to calculate the information concerning the roll angle of the vehicle 10. The ECU 15 sets the target spring control force of the electromagnetic actuator 13 based on the calculated information concerning the roll angle and using the set target spring control force, corrects the target drive force so as to reduce the roll angle of the vehicle 10.

With the electric suspension device 11 based on the fifth aspect, similarly to the electric suspension device 11 based on the fourth aspect, in addition to the effect in minimizing roll vibration of the vehicle 10 while keeping the vehicle 10 in a substantially horizontal position even in a situation where the vehicle 10 is traveling along a flat, curved road or a cross slope road, it is possible to reduce the power consumption due to the control to reduce roll vibration and improve the effect in reducing roll vibration in a range of frequencies to which human bodies are highly sensitive.

### Other Embodiment

The plural embodiments described above are examples embodying the present invention. These embodiments should not limit the interpretation of the technical scope of the present invention. The present invention can be implemented in various modes without departing from the spirit thereof or the main features thereof.

The description of the electric suspension device 11 according to the present invention, for example, illustrates a mode in which the electric suspension device 11 corrects the target damping force and target expansion-contraction force based on the roll velocity acquired by the information acquisition section 51 and uses the target drive force based on the corrected target damping force and expansion-contraction force to perform drive control for the electromagnetic actuator 13. The electric suspension device 11 thereby reduces roll vibration of the vehicle 10 while keeping the vehicle 10 in a substantially horizontal position. However, the present invention is not limited to this example.

The roll angle in the aforementioned embodiments may be replaced with pitch angle. Specifically, an electric suspension device 11 according to the present invention may be configured to reduce pitch vibration of the vehicle 10 while keeping the vehicle 10 in a substantially horizontal position by correcting the target damping force and target expansion-contraction force based on pitch velocity acquired by the information acquisition section 51 and uses the target drive force based on the corrected target damping force and expansion-contraction force to perform drive control for the electromagnetic actuator 13.

What is claimed is:

1. An electric suspension device, comprising:
an electromagnetic actuator which is arranged in parallel to a spring member provided between a body and a wheel of a vehicle and produces a drive force concerning damping operation and expansion-contraction operation;
an information acquisition section which acquires roll velocity of the vehicle;
a damping force calculation section which calculates a target damping force as a target value for the damping operation of the electromagnetic actuator; and
a drive controller which performs drive control for the electromagnetic actuator using a target drive force based on the target damping force calculated by the damping force calculation section, wherein
the damping force calculation section calculates a standard damping force of the electromagnetic actuator as a standard value, calculates a supplementary damping force which supplements the standard damping force based on the roll velocity acquired by the information acquisition section, and adds the calculated standard damping force and supplementary damping force to calculate the target damping force.

2. An electric suspension device, comprising:
an electromagnetic actuator which is arranged in parallel to a spring member provided between a body and a wheel of a vehicle and produces a drive force concerning damping operation and expansion-contraction operation;
an information acquisition section which acquires stroke speed of the electromagnetic actuator and roll velocity of the vehicle;
a damping force calculation section which calculates a standard damping force of the electromagnetic actuator as a standard value based on the stroke speed acquired by the information acquisition section and calculates a supplementary damping force which supplements the standard damping force based on the roll velocity acquired by the information acquisition section; and
a drive controller which sets the sum of the standard damping force and supplementary damping force calculated in the damping force calculation section as a target damping force which is a target value for the damping operation of the electromagnetic actuator, sets a target expansion-contraction force which is a target value for the expansion-contraction operation of the electromagnetic actuator, and performs drive control for the electromagnetic actuator using a target drive force based on the set target damping force and target expansion-contraction force.

3. The electric suspension device according to claim 2, wherein
the drive controller integrates information concerning the roll velocity acquired by the information acquisition section, with respect to time to calculate information concerning the roll angle of the vehicle, and
sets a target spring control force of the electromagnetic actuator based on the calculated information concerning the roll angle, and
by using the set target spring control force, corrects the target drive force to reduce the roll angle of the vehicle.

4. The electric suspension device according to claim 3, wherein
the drive controller applies a high-pass filter, which eliminates a trend, to the calculated information concerning the roll angle to acquire information concerning the roll angle with the trend eliminated,
sets the target spring control force of the electromagnetic actuator based on the acquired information concerning the roll angle, and
by using the set target spring control force, corrects the target drive force to reduce the roll angle of the vehicle.

5. The electric suspension device according to claim 2, wherein
the drive controller
applies a high-pass filter, which eliminates a trend, to the information concerning the roll velocity acquired by the information acquisition section to acquire information concerning the roll velocity with the trend eliminated,
integrates the acquired information concerning the roll velocity with respect to time to calculate information concerning the roll angle of the vehicle,
sets the target spring control force of the electromagnetic actuator based on the calculated information concerning the roll angle, and
by using the set target spring control force, corrects the target drive force to reduce the roll angle of the vehicle.
